(19) United States
(12) Patent Application Publication
(10) Pub. No.: US 2007/0223432 A1
(43) Pub. Date: Sep. 27, 2007

(54) Wi-Fi network connection management using location specific information

(76) Inventor: Sharma KV Badarinath, Bangalore (IN)

Correspondence Address: INTEL CORPORATION;c/o INTELLEVATE, LLC, P.O. BOX 52050, MINNEAPOLIS, MN, 55402, US

(21) Appl. No.: 11/448,255

(22) Filed: Jun. 6, 2006

(30) Foreign Application Priority Data
Mar. 21, 2006 (IN) 756/DEL/2006

(51) Int. Cl. H04Q 7/24

(52) U.S. Cl. 370/338; 455/456.1

(57) ABSTRACT

An embodiment of the present invention provides a wireless client capable of connection management using wireless client position specific information, wherein the position specific information is determined by the wireless client communicating with a mobile device in proximity to the wireless client that has knowledge of the mobile devices position. Alternatively, position specific information could be obtained from the Access points OR networks through beacons (OR probe request/response) during the network scan of the wireless client.

### BACKGROUND

Wireless networks have grown increasingly in importance and have varying uses. Wireless clients/adapters used in wireless networks may have to be configured with many parameters (connection, security, etc) to establish a successful connection in the wireless networks. Wireless connection management software may be used for configuring wireless clients.

To establish a wireless connection successfully, an end-user may need to pick up a specific profile for the present network and apply the same. As the network credentials which involve security settings for communication between an Access Point and the terminal would be different for each network, users may need to get different settings for different networks. Different offices, lobbies, coffee shops, airports and the like may have different profiles to be applied as the network settings would be different at each of the places

Thus, a strong need exists for techniques for wireless communication connection management using location specific information.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a typical use case scenario of one embodiment of the present invention; and

FIG. 2 provides a flow chart for wireless local area network connection management functionality using location specific information of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

An embodiment of the present invention provides automation of connection management when a user of a wireless client is mobile by taking location into consideration. As most of todays mobile devices are updated with their location information, connection management software may use the same information to pick up a wireless network's profile and appropriately apply it for use within a given wireless network. At present user needs to manually change the profile if they go from one location to another. User portability and the ability to relocate from one wireless network to another will be improved with regard to changing the profile as the connection management is automated.

Currently, when a Laptop is used for mobility and getting connected to a network, a user is required to scan for relevant networks and apply the network credentials by selecting the profiles manually. In an embodiment of the present invention, this feature may be automated by getting the location from a mobile device and using this information to select any appropriate profile to get connected.

Most of today's mobile service providers update the mobile device associated with the service providers—such as mobile phones used in a cellular network (although the present invention is not limited to cellular or any particular wide area networks)—with the location of the mobile user. This may be accomplished by the infrastructure associated with the mobile device. The same information may be used to arrive at the profile to be picked up to get connected to the nearest access point (AP); although it is understood that the present invention is not limited to wireless local area networks and APs associated therewith. In an embodiment of the present invention, the location information may be transferred to the Laptop via Bluetooth/IR and the connection management software may then decide on which profile to use to get connected.

In an embodiment of the present invention, a wireless-client (e.g. a laptop computer used in a wireless local area network) may automatically identify the appropriate network available for connection based on its physical location and connect using an applicable profile. At least an embodiment of the present invention provides essentially to make the wireless client (for example, connection management software) gain location information using mobile devices thru, for example, but not limited to, Infrared or Bluetooth modes of communication (which is by default available on most wireless clients and mobile devices), based on the location, and then select the appropriate profile and establish a connection.

Currently, mobile devices typically provide location information (service providers provide the location information). Wireless clients (e.g. a laptop in a wireless local area network) may communicate with mobile devices and gain the location information. Once the location information is available, wireless local area network configuration software can automatically select an appropriate profile, apply it and get the connection established. This reduces the effort from the user to a large extent in getting the connection established every-time they move from one network to the other. An embodiment of the present invention may use already available hardware infrastructure (mobile devices, such as mobile phones and wireless local area networks, such as wi-fi, enabled laptops, typically already have Infrared and/or Bluetooth capabilities) and this may be a software-only solution; however, the present invention does not necessarily need to be software only.

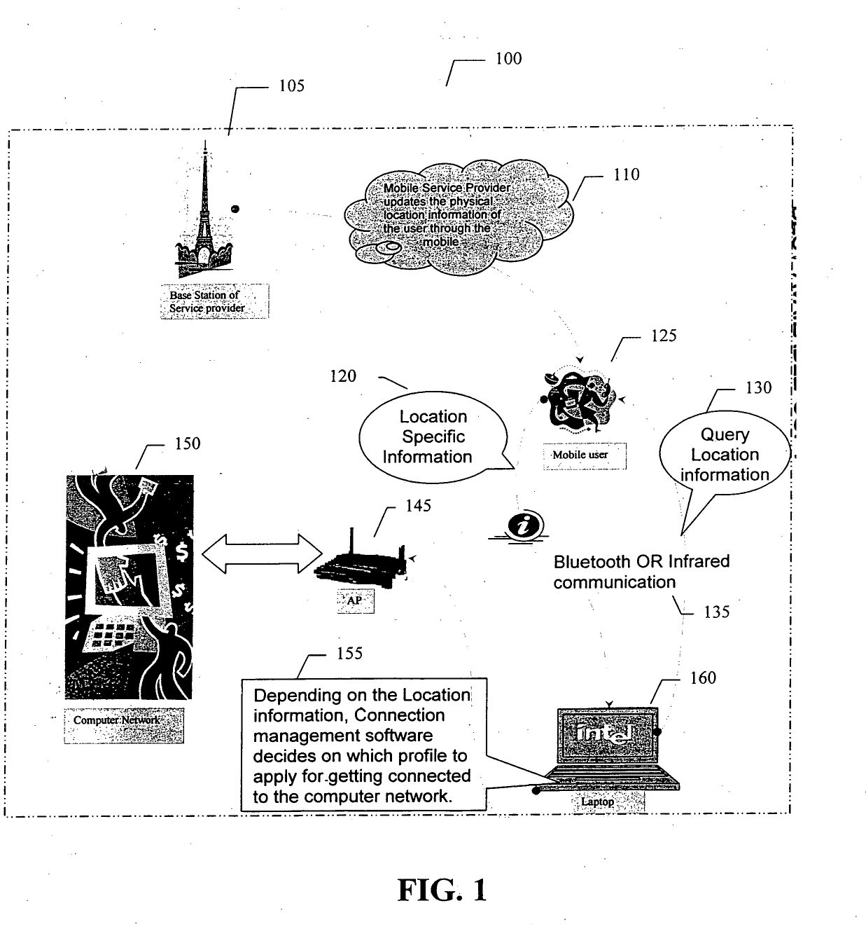

Turning now to the figures, FIG. 1 at 100, shows a typical use case scenario of an embodiment of the present invention. Base station (105) updates the Mobile user/device (125) about the present physical location information (110) of the user/device (125). Most of the mobile service providers give this service. Periodically mobile devices may get updated with the present physical location (120) of the mobile device.

Laptop (160) which may have lost the network connection because the user has moved from one geographical location to another may now query the user mobile for location information (130). Location information (120) may be a datastructure which could contain relevant information such as geographical information or optionally the (Secure Set Identifier) SSID of the network in the vicinity, and network credentials information; although the present invention is not limited in this respect. The mode of communication between the Laptop (160) and the Mobile (125) could be through Bluetooth or infrared channels (135). It is assumed that most of the laptops (160) and mobile phones (125) will have these capabilities. In an embodiment of the present invention, mobile phone (125) sends the location information (120) to the laptop (160).

Connection management software (155), which may be running in the laptop (160), may use the location information (120) received to arrive at the proper profile to get connected the nearby wireless local area network (such as, but not limited to, a wi-fi network) (150), via access point (AP) (145). Once the network connection is established, the laptop (160) and mobile device (125) may close their communication channels.

Users may have a profiles database for different wireless networks applicable at various physical locations. Laptop (160) (also referred to as a wireless client or wi-fi client) and mobile devices (125) may have short range wireless radio frequency communication (such as the Bluetooth short range wireless radio frequency communication technique) or infrared capabilities; although the present invention is not limited to these wireless communication techniques. Mobile service providers may provide physical location update service with accuracy.

An alternative to taking the location information (120) from the mobile device would be through a probe request and response (OR) beacons of the network. That is, when the user scans for the network using the connection management software, each network exposes its SSID, supported channels, BSSID and some vendor specific information etc. If the location information (120) is also part of the above said information, when the connection management software makes a scan for the nearby networks, each network responds with beacons with the aforementioned informations. Thus, the connection management software receives the location information during active or passive scanning for the networks with in the vicinity. Hence, if the network can provide the location information during the scanning process, the same information may be used to select the profile for the network from the database.

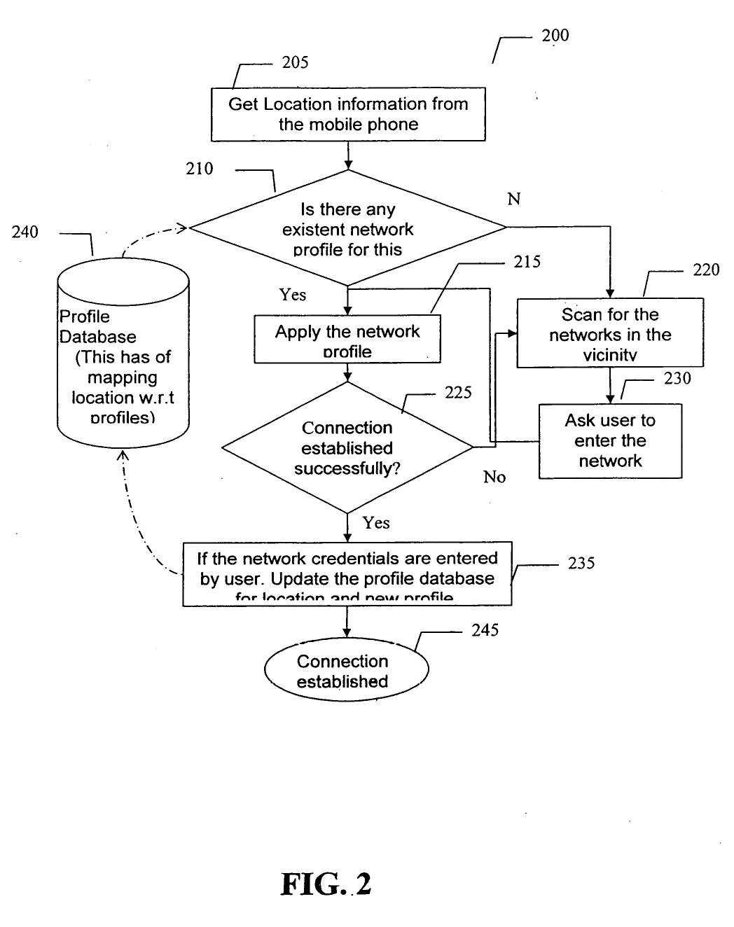

Turning now to FIG. 2 (200), is provided a flow chart for wireless local area network connection management functionality using location specific information of one embodiment of the present invention. Connection management software running in the laptop queries the mobile device regarding location information (205). As stated above, the mobile device may transfer the location information to the laptop via Bluetooth or Infrared communication channels. Connection management software searches the profile database for any network profile for the present geographical area at (210). If the profile is found, the software uses (215) the profile to get connected to the wireless local area network (225). If there is no profile for the existing location, the software may scan the network (220) for any APs and any wireless local area networks available in the vicinity. If found a user may be prompted to select the network for connection (230). The same profile may be updated (235) in the profile database (240) for location and network information to enable the software to automatically connect to the nearby network during subsequent use at the same location.

In an embodiment of the present invention, the present may be a software only implementation. Further, software implementations may require that mobile phones have software to transfer the location information and protocols established between mobile phone and laptop for transferring the location information. Connection management software running in the laptop should be able to establish the connection with a mobile phone, query the mobile for location information, use the location information to arrive at the proper profile for the network, apply the profile to get connected to the network and close the connection with the mobile phone.

Another embodiment of the present invention provides a machine-accessible medium that provides instructions, which when accessed, cause a machine to perform operations comprising using wireless client position specific information for connection management by a wireless client, wherein the position specific information is determined by the wireless client communicating with a mobile device in proximity to the wireless client that has knowledge of the mobile devices position. The machine-accessible medium may further comprise the instructions causing the machine to perform operations further comprising including in the connection management, a datastructure containing geographical information and wherein the wireless client may use the location information received to arrive at a proper profile from the datastructure to get connected to a nearby wireless network.

Yet another embodiment of the present invention provides a system, comprising a wireless client capable of connection management using the wireless client's position specific information and a mobile device in communication with the wireless client, wherein the position specific information is determined by the mobile device and communicated to the wireless client.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

I claim:

1. An apparatus, comprising:
a wireless client capable of connection management using wireless client position specific information, wherein said position specific information is determined by said wireless client communicating with a mobile device in proximity to said wireless client that has knowledge of said mobile devices position.

2. The apparatus of claim 1, wherein said communication between said wireless client and said mobile device is via a short range radio frequency communication channel.

3. The apparatus of claim 1, wherein said communication between said wireless client and said mobile device is via an infrared channel.

4. The apparatus of claim 1, wherein said mobile device is a mobile phone and said position information is provided to said mobile phone by the infrastructure associated with said mobile phone.

5. The apparatus of claim 1, wherein said connection management further uses a datastructure containing geographical information and wherein said wireless client uses said position information received to arrive at a proper profile from said datastructure to get connected to a nearby wireless network.

6. The apparatus of claim 1, wherein said wireless client is a notebook computer and said mobile device is a mobile phone in communication with said notebook computer and wherein said mobile device is aware of its geographic location and capable of providing said geographic information to said notebook computer to facilitate connection by said notebook computer to a wireless local area network.

7. The apparatus of claim 5, wherein said datastructure contains a location information element which is present in profile database for different wireless networks applicable at various physical locations.

8. The apparatus of claim 7, wherein if there is no profile for an existing location, said wireless client scans said wireless networks for any wireless local area network access points available in the vicinity and, if found, a user of said wireless client is prompted to select said wireless local area network access point to get connected and wherein said profile is updated in said profile database for location and network information.

9. The apparatus of claim 1, wherein said connection management is capable of establishing a connection with said Mobile device, querying said mobile device for location information, using said location information to arrive at a proper profile for said network, applying the profile to get connected to the network and closing the connection with said mobile device.

10. A method, comprising:
using wireless client position specific information for connection management by a wireless client, wherein said position specific information is determined by said wireless client communicating with a mobile device in proximity to said wireless client that has knowledge of said mobile devices position.

11. The method of claim 10, further comprising using a short range radio frequency communication channel for communication between said wireless client and said mobile device.

12. The method of claim 10, further comprising using an infrared channel for communication between said wireless client and said mobile device.

13. The method of claim 10, further comprising providing said position information by a wireless communication infrastructure associated with said mobile device.

14. The method of claim 10, further comprising including in said connection management a datastructure containing geographical information and wherein said wireless client uses said location information received to arrive at a proper profile for getting connected to a nearby wireless network.

15. The method of claim 10, wherein said wireless client is a notebook computer and said mobile device is a mobile phone in communication with said notebook computer and wherein said mobile device is aware of its geographic location and capable of providing said geographic information to said notebook computer to facilitate connection by said notebook computer to a wireless local area network.

16. The method of claim 14, further comprising populating said datastructure with a location specific information along with optional parameters like profile database specific info for different wireless networks applicable at various physical locations.

17. The method of claim 16, further comprising if there is no profile for an existing location, scanning said wireless network by said wireless client for any wireless local area network access points available in the vicinity and if there is no profile for an existing location, a user of said wireless client is prompted to select said wireless local area network access point to get connected and said profile is updated in said profile database for location and network information.

18. The method of claim 10, further comprising establishing a connection with said Mobile device, querying said mobile device for location information, using said location information to arrive at a proper profile for said network, applying said profile to get connected to said network and closing said connection with the mobile device.

19. A machine-accessible medium that provides instructions, which when accessed, cause a machine to perform operations comprising:
using wireless client position specific information for connection management by a wireless client, wherein said position specific information is determined by said wireless client communicating with a mobile device in proximity to said wireless client that has knowledge of said mobile devices position.

20. The machine-accessible medium of claim 19, further comprising said instructions causing said machine to perform operations further comprising using a short range radio frequency communication channel for communication between said wireless client and said mobile device.

21. The machine-accessible medium of claim 19, further comprising said instructions causing said machine to perform operations further comprising using an infrared channel for communication between said wireless client and said mobile device.

22. The machine-accessible medium of claim 23, further comprising said instructions causing said machine to perform operations further comprising including in said connection management a datastructure containing geographical information and wherein said wireless client uses said location information received to arrive at a proper profile from said datastructure to get connected to a nearby wireless network.

23. A system, comprising:
a wireless client capable of connection management using said wireless client's position specific information and a mobile device in communication with said wireless client, wherein said position specific information is determined by said mobile device and communicated to said wireless client.

24. The system of claim 23, further comprising a datastructure containing geographical information usable by said wireless client to arrive at a proper profile to get connected to a nearby wireless network.

25. The system of claim 23, wherein said mobile device is a mobile phone and said position information is provided to said mobile phone by the infrastructure associated with said mobile phone.

26. The system of claim 23, further comprising a short range wireless transceiver associated with said mobile device capable of transmitting said position specific information from said mobile device to said wireless client.

27. The system of claim 23, further comprising an infra red transmitter associated with said mobile device capable of transmitting said position specific information from said mobile device to said wireless client.
